(19) United States
(12) Patent Application Publication
(10) Pub. No.: US 2015/0252242 A1
(43) Pub. Date: Sep. 10, 2015

(54) HIGH THERMAL CONDUCTIVITY RESIN COMPOSITION

(71) Applicant: DUPONT MITSUI FLUOROCHEMICALS CO LTD, Wilmington, DE (US)

(72) Inventors: HOAI-NAM PHAM, Shizuoka-Shi (JP); Mineyuki Noda, Shizuoka-Shi (JP); Osamu Hayakawa, Shizuoka-Shi (JP)

(21) Appl. No.: 14/629,947

(22) Filed: Feb. 24, 2015

(30) Foreign Application Priority Data
Mar. 7, 2014 (JP) 2014-045420

(51) Int. Cl. C09K 5/14; C08K 3/38

(52) U.S. Cl. CPC C09K 5/14; C08K 3/38; C08K 2003/382

(57) ABSTRACT

Provided is a thermoplastic resin composition having excellent thermal conductivity and high electrical insulating properties, and having excellent flexibility in comparison to ceramic molded bodies and thermoset resin compositions. The resin composition contains 20-60 volume percent of thermoplastic resin and 40-80 volume percent of boron nitride. The boron nitride is made up of spherical boron nitride particles and flat boron nitride particles. The spherical boron nitride particles have average particle size of 50-300 μm and aspect ratio or 1-2. The flat boron nitride particles have average particle size of 8-100 μm and aspect ratio of 30-300. The volume ratio of the spherical boron nitride particles with respect to the total amount of boron nitride is 75 vol %-99 vol %. Further provided are melt molded products of this thermoplastic resin composition and a method for the manufacture of such melt molded products.

### FIELD OF THE DISCLOSURE

The present disclosure is directed to a high thermal conductivity resin compositions containing thermoplastic resin, spherical boron nitride particles and flat boron nitride particles.

### BACKGROUND OF THE DISCLOSURE

In semiconductors, heat generation increases along with miniaturization and higher integration, so materials used to make semiconductors must have high thermal conductivity. It is also necessary that heat dissipating insulators have good electrical insulation properties. This is especially the case in power semiconductors used for electric power control and power modules that embed power semiconductor elements, since the heat generated in such during operation is significant. In such, materials that can efficiently disperse heat are highly desired. In order to efficiently remove heat, not only does a material need to have high heat conductivity, but it also must be closely attached to the heat generating body. In automobiles, where vibrational forces are large, it is preferable for the heat generating body to also be flexible so that it can accommodate structural movements.

Ceramic sheets find commercial use as a heat dissipating material with high thermal conductivity as well as high insulating properties. However ceramics have the drawback that they cannot be easily processed into desired shapes, and do not have flexibility. Further, there is also the drawback that the weight of ceramics can result in a part that is too heavy for its intended utility. Further, it is difficult to adhere ceramics to metal substrates, requiring adhesion solutions that increase overall costs.

Thermally conductive resin composition consisting of resin and thermally conductive filler has been proposed, but the thermal conductivity of these solutions is still insufficient. Further, when using thermosetting resin, there is the drawback that the resin will not have adequate flexibility after curing. Further, silicone and epoxy resins that find utility as thermosetting resins do not have high breakdown voltages, and if used at high temperatures, they will degrade and will not be able to maintain their physical properties. It is thus difficult to use them for a power module for next-generation vehicles, a utility that demands heat resistance and high electrical insulation properties.

Boron nitride (BN) is known as a filler with good thermal conductivity and insulating properties, and since it addresses the problem of the orientation of the thermal conductivity due to the filler shape, BN particles consisting of plate-like BN that are aggregated without orientation have been put to practical use. For example, as disclosed in U.S. Pat. No. 5,854,155. However, the thermal conductivity of the sheet disclosed in this patent is low, at around 4.76 W/mK in the thickness direction, which is insufficient for most utilities.

Published US patent application US 2011/223427 A1 discloses a fluorine resin and an insulating thermal conductive sheet consisting of thermal conductive inorganic particles consisting of boron nitride. However, a sheet obtained from this material requires a complex process in which a plurality of sheet-like molded bodies are overlapped and rolled, leading to production complications and therefore undesirable costs. The obtained sheet has thermal conductivity in the in-plane direction higher than the thermal conductivity in the thickness direction. Further, in order to obtain high thermal conductivity, it is also necessary to use 90 weight percent of boron nitride, creating problems around cost and mold ability of such compositions.

Japanese Laid Open Patent Application No. 2013-23664 discloses a thermally conductive composition of thermally fusible fluorine resin and thermally conductive filler. However, since fluorine resin uses a dispersion and forms a coated film by coating, it can only be formed into a thin film. Further, the maximum thermal conductivity of the obtained film is low at 3-4 W/mK, which is insufficient for most applications.

Japanese Laid Open Patent Application No. 2005-343728 discloses a composition in which two types of boron nitride powders that have a maximal value B in the 5-30 μm region and a maximal value A in the 100-300 μm region of the frequency particle size distribution, are included in at least one of rubber or resin. However, the thermal conductivity of the obtained composition is in all cases low at less than or equal to 2 W/mK, which is insufficient for most applications.

### SUMMARY OF THE DISCLOSURE

An object of the present invention is to provide a composition having excellent thermal conductivity and high electrical insulating properties, and further having excellent flexibility in comparison to ceramic molded bodies and thermoset resin compositions.

The present inventors carried out dedicated research and discovered that a resin composition with excellent thermal conductivity and high electrical insulating properties as well as excellent flexibility can be made by combining thermoplastic resin and boron nitride as a filler, and by using spherical boron nitride particles and flat boron nitride particles together in specific amounts as taught herein.

One embodiment of the present invention is a resin composition comprising 20-60 vol % of thermoplastic resin and 40-80 vol % of boron nitride. The boron nitride comprises spherical boron nitride particles and flat boron nitride particles, wherein the average particle size of the spherical boron nitride particles is 50-300 μm and the aspect ratio is 1-2, and the average particle size of the flat boron nitride particles is 8-100 μm and the aspect ratio is 30-300, and wherein the volume ratio of the spherical boron nitride particles with respect to the total amount of boron nitride is 75 vol %-99 vol %.

In one embodiment of the present resin composition, the value of the average particle size of the spherical boron nitride particles divided by the average particle size of the flat boron nitride particles is in the range of 1-10. In one embodiment of the present resin composition, the average particle size of the spherical boron nitride particles is 60-100 μm and its aspect ratio is 1-2, and the average particle size of the flat boron nitride particles is 20-50 μm and its aspect ratio is 60-300. In one embodiment of the present resin composition, the volume ratio of the spherical boron nitride particles with respect to the total amount of the boron nitride is 85 vol %-98 vol %. In one embodiment of the present resin composition, the amount of the thermoplastic resin is 30-50 vol % and the amount of boron nitride is 50-70 vol %.

In one embodiment of the present resin composition the thermoplastic resin is a fluorine resin. In a preferred embodiment of the present invention, the thermoplastic resin is one or more perfluoro resin, for example, PTFE, PFA, FEP, or tetrafluoroethylene, hexafluoropropylene perfluoro(alkyl vinyl ether) copolymer.

The resin composition of the present invention has excellent thermal conductivity and high electrical insulating properties, and it further has excellent flexibility when compared to ceramic molded bodies and thermoset resin compositions. A molded body made by molding the resin composition of the present invention is useful as a heat dissipating material for electronic components, printed circuit board material, housing material for LED lighting, substrate material for small power supplies, and sealing material and case material for secondary batteries.

Another embodiment of the present invention is a method to manufacture the present resin composition into a molded body. Therefore, the present invention includes a manufacturing method for a molded product wherein thermoplastic resin and boron nitride filler are mixed together, for example by the method dry blending, wet blending, or co-coagulation, after which it is melt molded.

Another embodiment of the present invention is a molded product made from the resin composition of the present invention. In one embodiment of the molded product has a thermal conductivity of greater than or equal to 8.5 W/mK. The molded product of the present invention can take the form of a sheet, a film, or a tube.

The resin composition of the present invention has excellent thermal conductivity and high electrical insulating properties, and it further has excellent flexibility when compared to ceramic molded bodies and thermosetting resin compositions. Further, a molded body made by molding the resin composition of the present invention is useful as a heat dissipating material for electronic components, printed circuit board material, housing material for LED lighting, substrate material for small power supplies, and sealing material and case material for secondary batteries.

### BRIEF DESCRIPTION OF THE DRAWINGS

The drawings described herein are for illustration purposes only. The drawings are not intended to limit the scope of the present disclosure in any way.

FIG. 1 shows a photograph (×180 magnification) in which a film molded from the resin composition prepared in Example 1 was cooled in liquid nitrogen, and after which it was fractured and the fractured surface observed with an SEM.

FIG. 2 shows a photograph (×800 magnification) in which a film molded from the resin composition prepared in Example 1 was cooled in liquid nitrogen, and after which it was fractured and the fractured surface was observed with an SEM.

### DETAILED DESCRIPTION

### I—The Resin Composition

In one embodiment the present invention is a resin composition comprising thermoplastic resin and boron nitride.

(1) Thermoplastic Resin

The thermoplastic resin comprising the composition of the present invention can be selected from well-known thermoplastic resins. Examples of thermoplastic resins include polyethylene, polypropylene, polyvinyl chloride, polystyrene, AS resin, ABS resin, acrylic resin, polyamide, polyacetal, polyester, cyclic polyolefin, polycarbonate, polymethylpentene, polyphenylene ether, polyphenylene sulfide, liquid crystal polymer, polyether imide, polyallylate, polysulfone, polyether sulfone, thermoplastic polyimide, polyamide imide, polyether ether ketone (PEEK), and fluorinated resins.

From the point of view of heat resistance, it is preferable to use for the thermoplastic resin an engineering plastic that can be used at high temperatures of greater than or equal to 100° C. Further, it is preferable to use engineering plastic with melting point greater than or equal to 200° C., preferably greater than or equal to 250° C., and more preferably greater than or equal to 300° C.

Further, from the point of view of electrical properties (e.g., dielectric constant, dielectric loss), chemical resistance, and weather resistance, it is preferable to use as the thermoplastic resin a fluorine resin that has excellent chemical stability. The fluorine resin used in the present invention can be selected from the thermoplastic fluorine resins. Specific examples include polymers and copolymers of monomers selected from tetrafluoroethylene, chlorotrifluoroethylene, hexafluoropropylene, perfluoro(alkyl vinyl ether), vinylidene fluoride and vinyl fluoride, or a copolymer of these monomers with monomers that have a carbon-carbon double bond such as ethylene, propylene, butylene, pentene, and hexene, or with monomers that have a carbon-carbon triple bond such as acetylene, propylene and the like. Specific examples of thermoplastic fluorine resins include polytetrafluoroethylene, tetrafluoroethylene perfluoro(alkyl vinyl ether) copolymer (also called PFA), tetrafluoroethylene hexafluoropropylene copolymer (also called FEP), tetrafluoroethylene hexafluoropropylene perfluoro (alkyl vinyl ether) copolymer, tetrafluoroethylene ethylene copolymer (also called ETFE), polyvinylidene fluoride, polychlorotrifluoroethylene, and chlorotrifluoroethylene ethylene copolymer.

Of these thermoplastic fluorine resins, perfluoro resins such as PTFE, PFA, FEP, and tetrafluoroethylene hexafluoropropylene perfluoro(alkyl vinyl ether) copolymer are favorably used from the point of view of heat resistance and electrical properties (dielectric constant, dielectric loss). Also, for the thermoplastic resin, which is a raw material of the present invention, two or more types of thermoplastic resin can be blended and used according to the characteristics desired.

Further, from the point of view of molding ability during high temperature molding, it is preferable to use a resin having fluidity at a temperature that is greater than or equal to the melting point. Specifically, it is preferable to use a perfluoro resin having a melt flow rate (MFR) that is greater than 1 g/10 min. Examples of these kinds of melt flowable resins include PFA, FEP, and tetrafluoroethylene hexafluoropropylene perfluoro(alkyl vinyl ether) copolymer. When considering the process and mold ability, it is preferred to use PFA that has a high melting point and excellent thermal fluidity. In the case of using PFA, the alkyl group of the perfluoro(alkyl vinyl ether) in the PFA has 1-5 carbon atoms, and preferably 1-3.

In the case of using PFA or FEP as the thermoplastic resin of the present invention, it is preferable for its melt flow rate (MFR) to be greater than or equal to 1 g/10 min, and more preferable for it to be greater than or equal to 10 g/10 min, and especially preferable for it to be greater than or equal to 20 g/10 min. By selecting a thermoplastic resin with large fluidity during melting, the raw material benefits can be obtained. For example, it becomes easier for resin to enter in the gaps of the filler when melt-molding the thermoplastic resin composition, and whereas high melt viscosity thermoplastic resins may cause the filler structure to be destroyed as a result of high shear forces in the melt.

If the melt fluidity of the thermoplastic resin is too large, that is, if the molecular weight of the thermoplastic resin is too small, then the entanglement of molecular chains becomes too small and the resin becomes brittle at temperatures below the melting point or the glass transition point. As a result, the flexibility of the molded product declines and undesirably becomes brittle and easy to crack. For this reason, from the point of view of improving flexibility, in the case of using PFA or FEP, it is preferable that the MFR is less than or equal to 100 g/10 min, and more preferable that it is less than or equal to 70 g/10 min, and especially preferable that it is less than or equal to 50 g/10 min. The composition ratio of each monomer that configures the copolymer in the thermoplastic resin of the present invention is not particularly limited, but it can be appropriately adjusted according to the flexibility, hardness, and strength that are desired of the resin for use.

In summary, in the case of using perfluoro resin as the thermoplastic resin of the present invention, the MFR is at least 1 g/10 min, and preferably from 10 g/10 min-70 g/10 min, and more preferably from 20 g/10 min-50 g/10 min. From the point of view of improving the flexibility of the molded product, a thermoplastic resin having an MFR of from 1 g/10 min-50 g/10 min, and preferably from 1 g/10 min-10 g/10 min is of utility as well.

(2) Boron Nitride Component

The composition of the present invention is characterized by comprising boron nitride (BN) as filler. Further, this boron nitride comprises spherical boron nitride particles and flat boron nitride particles.

(i) Spherical Boron Nitride Particles

The spherical boron nitride particles comprising the resin composition of the present invention are spherical particles, and their aspect ratios (i.e., the major axis/minor axis of the spherical particles) is from 1-2. These spherical boron nitride particles can be manufactured by, for example, known methods, such as those disclosed in Japanese Laid Open Patent Application No. 2012-056818 and PCT publication WO 2006/023860 A2.

When the aspect ratio of these spherical boron nitride particles is larger than 2, problems can occur depending on the molding conditions in which the spherical boron nitride particles are oriented in the flow direction of the melt molding inside the molded product made by molding the resin composition, thereby reducing the thermal conductivity in a particular direction.

The average particle size of the spherical boron nitride particles is 50-300 μm, preferably 55-200 μm, and more preferably 60-100 μm. It is thought that by using spherical boron nitride particles with relatively large particle sizes, the interface between the thermoplastic resin and BN filler will be reduced inside the resin composition molded product, and an efficient thermal conduction path is formed, and the thermal conductivity is improved. Using fillers with relatively large particle sizes also has the effect of suppressing the rise of melt viscosity when melt-molding the thermoplastic resin composition. If the average particle size of the spherical particles is smaller than 50 μm, thermal conductivity is degraded, and will negatively affect its mold ability due to the rise in melt viscosity. Further, if the average particle size exceeds 300 μm, problems occur, such as degradation of the surface state of the molded product, and thin sheets (with a thickness that is less than or equal to the particle size of the filler), cannot be easily produced.

(ii) Flat Boron Nitride Particles

The resin composition of the present invention also comprises flat boron nitride particles. By including these two types of boron nitride particles, spherical boron nitride particles and flat boron nitride particles, due to the flat boron nitride particles being sandwiched between two or more spherical boron nitride particles inside the molded product made from the resin composition, for example, when made into a sheet, the thermal conductivity in the surface direction is improved. In the comparative case of only using flat boron nitride particles, since it will be oriented in the flow direction during melt-molding, the thermal conductivity in the surface direction of the obtained sheet will become worse in comparison to the longitudinal direction. This problem is solved by the present invention of using two different types of BN particles. Further, the flat boron nitride particles become the conduction path between the spherical boron nitride particles, so it has the effect of improving the thermal conductivity of the molded product.

The flat boron nitride particles are particles of boron nitride having a plate-like shape due to their crystal structure, and that can be commercially obtained. The average particle size of these flat boron nitride particles is 8-100 μm, preferably 15-70 μm, and more preferably 20-50 μm. If the average particle size of the particles is smaller than 8 μm, the flat boron nitride particles will be sandwiched by spherical boron nitride particles that are used together, and, for example, when made into a sheet, the effect of improving thermal conductivity in the surface direction cannot be obtained. The aspect ratio of the flat boron nitride particles is calculated as the average particle size/plate thickness. The flat boron nitride particles of the present invention have an aspect ratio of 30-300, preferably from 60-300.

(iii) Compositional Ratio of Boron Nitride Particles

In the resin composition of the present invention, the volume ratio of the spherical boron nitride particles with respect to the total amount of the boron nitride is 75 vol %-99 vol %, preferably 85 vol %-98 vol %, more preferably 90 vol %-98 vol %, and especially preferably 93 vol %-97 vol %. The total amount of boron nitride means the total amount of the spherical boron nitride particles and the flat boron nitride particles, but in the case that it contains boron nitride of another form, the amount that includes this boron nitride as well will become the total amount of boron nitride.

In the present invention, surprisingly, by further using flat boron nitride particles in addition to spherical boron nitride particles, it was found that the flexibility of the molded body made by molding the resin composition is improved. It is believed that by combining spherical boron nitride particles and flat boron nitride particles, flat boron nitride particles are randomly disposed between the spherical boron nitride particles, so when the sample is bent, while cracks will be easily generated between the spherical boron nitride particles if it is only spherical boron nitride particles, generation and growth of cracks are inhibited by the flat boron nitride particles.

(iv) Particle Size Ratio of Boron Nitride Particles

The resin composition of the present invention is characterized by comprising two types of boron nitrides: spherical boron nitride particles and flat boron nitride particles. Further, it is preferable that the value for the average particle size of spherical boron nitride particles divided by the average particle size of flat boron nitride particles is in the range of 1-10, more preferably 1.5-5, and especially preferably 2-3.5. When the value for the average particle size of spherical boron nitride particles divided by the average particle size of flat boron nitride particles is less than 1, that is, in the case where average particle size of flat boron nitride particles is greater than the average particle size of spherical boron nitride particles, there is a problem. In this case, the effect of thermal conductivity in the surface direction being improved, for example, when made into a sheet, due to the flat boron nitride particles being sandwiched, cannot be obtained. Further, in this case, since the number of particles of flat boron nitride particles will be fewer than spherical boron nitride particles, there is the problem that the improvement effect in the thermal conductivity due to adding flat boron nitride particles (improvement effect due to the flat boron nitride particles being sandwiched between the spherical boron nitride particles and the formation of a conduction path between the particles) cannot be sufficiently obtained.

On the other hand, when the value for the average particle size of spherical boron nitride particles divided by the average particle size of flat boron nitride particles is greater than 10, since the flat boron nitride particles are too small in comparison to the spherical boron nitride particles, the spherical boron nitride particles will not become a steric barrier and it will become more difficult to form a conduction path between the particles, so an improvement effect in thermal conductivity cannot be obtained.

In the present specification, by average particle size is meant the particle size at 50% cumulative value (volume basis) in the grain size distribution obtained by laser diffraction scattering method.

(3) The Compositional Ratio of Thermoplastic Resin and Boron Nitride

The resin composition of the present invention is characterized by comprising 20-60 vol % of thermoplastic resin and 40-80 vol % of boron nitride. The volume composition of the boron nitride taking up the resin composition of the present invention (the total of the spherical boron nitride particles and flat boron nitride particles) is 40-80 vol %, preferably 50-70 vol %, and more preferably 50-65 vol %. When the volume composition ratio of the boron nitride, which is the filler, exceeds 80 vol %, the flexibility of the produced molded product will decline and it will become brittle. Further, in this case, the melting viscosity will increase and the mold ability will decline, creating a problem in which processing of the resin composition will become difficult, and further, there is the problem that cost due to the filler will increase.

In order to obtain the necessary thermal conductivity, the volume composition ratio of boron nitride in the resin composition of the present invention is greater than or equal to 40 vol %. In other words, in the resin composition of the present invention, by including 20-60 vol % of thermoplastic resin, a molded product that has more flexibility in the thermoplastic resin to be combined can be made. For this reason, a sheet that will not break but rather will bend can be made from the resin composition of the present invention. The obtained sheet is especially suitable for use under an environment experiencing much vibration, such as use in an automobile, or as a heat dissipating material that is required to be flexible in order to change its shape along with the shape of the heat generating body.

(4) Optional Additives

Fillers besides spherical boron nitride particles and flat boron nitride particles, for example inorganic fillers and organic fillers, can be added as appropriate to the resin composition of the present invention, according to the desired characteristics. Further, one or more types of other commonly used additives, such as stabilizers (heat stabilizers, UV absorbers, light stabilizers, antioxidants, and the like), dispersing agents, antistatic agents, colorants, and lubricants, and the like, can be combined and used with the resin composition of the present invention.

II—Molded Product Manufactured from the Resin Composition of the Present Invention, and its Manufacturing Method

The resin composition of the present invention, as described above, comprises thermoplastic resin and boron nitride. Further, the molded product of the present invention is preferably molded by a well-known melt-molding method after mixing the component thermoplastic resin and boron nitride (spherical boron nitride particles and flat boron nitride particles) with other additives, etc., if necessary, using a method such as dry blending, wet blending, or co-coagulation. Wet blending includes a method to mix resin and filler in a slurry state with water and solvent as a mixed medium, and a varnish method in which, when the resin is solvent-soluble, the resin is dissolved in a solvent and the resin solution (varnish) and filler are mixed. The resin composition of the present invention comprises spherical boron nitride particles and flat boron nitride particles, and by combining those with differences in the shapes of the particles or the particle sizes are different, the conductivity and other properties, are improved. For this reason, in the melt-kneading method in which thermoplastic resin is mixed in a melted state, there is the risk that especially spherical boron nitride particles will be destroyed due to the shear force during kneading.

For the melt-molding method, well-known melt-molding methods such as melt extrusion, injection molding, blow molding, transfer molding, melt compression etc., can be used, but since it is preferable to not apply shear force during molding, melt extrusion and melt-compression molding are preferable, and melt compression molding is especially preferable. Further, regarding the pressure when molding with melt compression molding, if the pressure is too high, especially when aggregates of flat boron nitride particles are used as the spherical boron nitride particles, it will lead to the destruction of boron nitride aggregates during pressurization, and as a result, there is the risk that the thermal conductivity will decline.

The molded product of the present invention that is obtained in the way described above comprises thermoplastic resin and boron nitride (spherical boron nitride particles and flat boron nitride particles), so the flat boron nitride particles are randomly oriented due to the steric barrier by the spherical boron nitride particles, and further, since the flat boron nitride particles will become the conduction path between the spherical boron nitride particles, it has high thermal conductivity. The thermal conductivity of the molded product of the present invention is preferably greater than or equal to 8.5 W/mK, and more preferably greater than or equal to 9.5 W/mK.

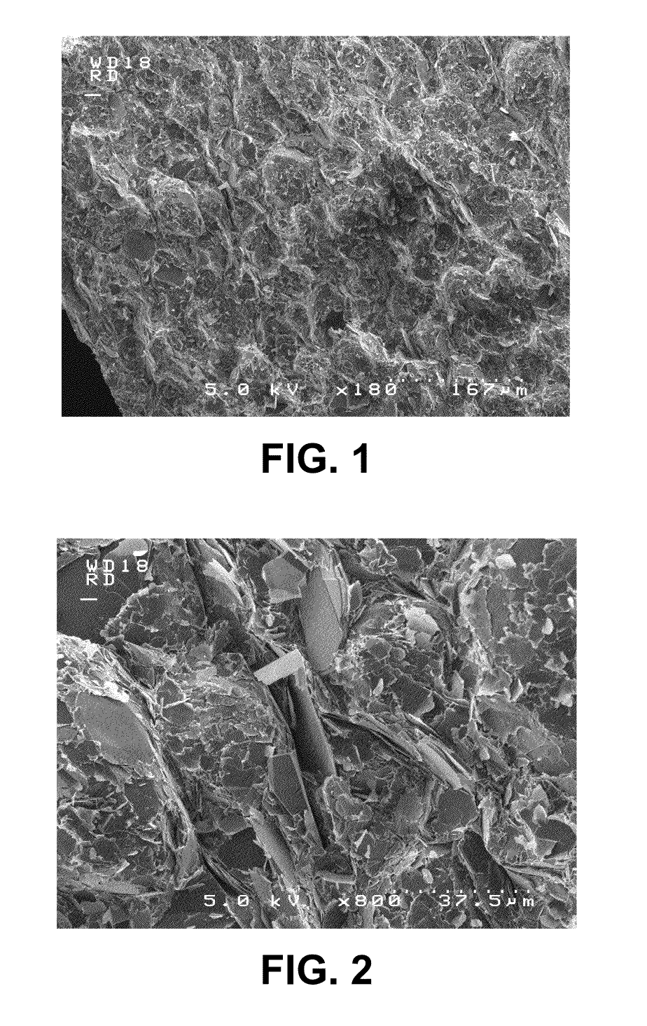

Further, since the flat boron nitride particles are randomly oriented between the spherical boron nitride particles, as can be appreciated from FIG. 1 and FIG. 2, the molded product of the present invention has high flexibility as well. Regarding the flexibility of the molded product of the present invention, the crack generating angle is greater than or equal to 20°, preferably greater than or equal to 30°, and especially preferably greater than or equal to 70°.

### EXAMPLES

### Measurement of the Physical Properties of the Raw Materials Melting Point

The melting point of the thermoplastic resin was measured using a differential scanning calorimeter (Pyris Type 1 DSC, Perkin Elmer). A 10 mg of sample was weighed and put in a special aluminum pan, crimped, the placed in the DSC main body and heated from 150° C. to 360° C. at a rate of 10° C./min. The melting peak temperature (Tm) was calculated from the melting curve obtained at this time.

Melt Flow Rate (MFR)

The melt flow rate (MFR) of the thermoplastic resin was obtained, in compliance with ASTM D-1238-95, using a melt indexer (Toyo Seiki Co., Ltd) having a corrosion resistant cylinder, die, and piston. A 5 g amount of sample powder was filled in the cylinder, maintained at 372±1° C. and retained for 5 minutes, after which, under a load of 5 kg (piston and weight), it was extruded through a die orifice, and the extruded amount per time (g/10 min) was measured as the MFR.

Definition and Measurement Method of the Aspect Ratio

(i) Spherical Boron Nitride Particle Aspect Ratio

Boron nitride particles were observed using a scanning electron microscope (SEM, Hitachi, Ltd., S-4500), and the major axis/minor axis of the particles was made the aspect ratio (n=30).

(ii) Flat Boron Nitride Particles Aspect Ratio

The average particle size of the particles was measured with laser diffraction scattering method, as the 50% cumulative value (volume basis) in the grain size distribution. Next, since the shape of the flat boron nitride particles is plate-like, the thickness of the plate was measured with the above-described scanning electron microscope (n=30). The average particle size divided by the plate thickness is the aspect ratio for the flat boron nitride particles.

### Evaluation Methods for the Resin Composition of the Present Invention

Measurement of Thermal Conductivity

The thermal conductivity was evaluated using a molded product in which the resin composition was molded into a circular disc film. Using a compression molding press (Hot Press WFA-37, Sinto Metal Industries, cylinder diameter 152 mm), the composition was put in a prescribed metal mold (55 mm diameter, 30 mm height), and after the resin was melted by maintaining at 360° C. for 15 minutes, it was compressed until the resin ran off at a prescribed pressure, then cooled for 15 minutes at room temperature, then molded to a circular disc of 55 mm in diameter and 1 mm in thickness, to make a molded product (sample 1).

Further, using a laser flash thermal conductivity measurement device (Netzsch Ltd., LFA 457) that is in compliance with JIS R1611, the thermal diffusivity of the circular disc film molded product (sample 1: thickness 1 mm) in the thickness direction was measured, and the specific heat was measured, and the thermal conductivity was calculated based on the following formula:

Thermal conductivity(W/mK)=thermal diffusivity(mm²/s)×density(g/cm³)×specific heat(J/kgK)

The density was calculated from the weight and thickness of the circular disc film.

Breakdown Voltage Measurement

Using the above-described compression molding press, the composition was put in a prescribed metal mold (55 mm diameter, 30 mm height), and after the resin was melted by maintaining at 360° C. for 15 minutes, it was compressed until the resin ran off at a prescribed pressure, then cooled for 15 minutes then molded to a circular disc of 55 mm in diameter and 200 μm in thickness, to make a molded product (sample 2).

Using a YSS type withstanding voltage breakdown test machine (Yasuda Seiki Ltd., No. 175), in compliance with JIS C-2110, the breakdown voltage was measured at room temperature.

Measurement of Flexibility

The flexibility of the molded product obtained from the resin composition was evaluated from the measurement of the crack generation angle and the ranking of the visual evaluation of brittleness, in the way described below.

(i) Crack Generating Angle

The circular disc shaped molded product described above (sample 2: thickness 200 μm) was placed on a horizontal surface and the two end points were picked up with tweezers, and the angle at which a crack is generated, when one of the end parts was picked up so that the center portion of the circle would bend, was measured.

(ii) Brittleness Ranking

The brittleness of the above-described circular disc shaped molded product (sample 2: thickness 200 μm) was evaluated by visually observing the samples used for the crack generating angle, with a three-step scale of ∘ (least brittle), Δ, and x (most brittle), as the brittleness rank.

### Raw Materials

The following raw materials were used for the Examples and Comparative Examples of the present invention.

Thermoplastic Resin PFA1-MFR: 40 g/10 min, melting point 304° C. Powdered tetrafluoroethylene/perfluoro (propylvinyl ether) copolymer obtained by emulsion polymerization.

PFA2-MFR: 75 g/10 min, melting point 300° C. Powdered tetrafluoroethylene/perfluoro (propylvinyl ether) copolymer obtained by emulsion polymerization.

PFA3-MFR: 2 g/10 min, melting point 301° C. Du Pont-Mitsui Fluorochemicals Co., Ltd. Teflon (Registered Trademark) PFA 959HP Plus.

PFA4-MFR: 2 g/10 min, melting point 308° C. Du Pont-Mitsui Fluorochemicals Co., Ltd. Teflon (Registered Trademark) PFA 350-J.

PEEK—melting point 343° C. Victrex Japan Ltd., PEEK-450PF

Spherical Boron Nitride Particles

Denki Kagaku Kogyo Co., Ltd., SGPS, average particle size 12 μm. Aspect ratio 1-2

Denki Kagaku Kogyo Co., Ltd., FP40, average particle size 40 μm. Aspect ratio 1-2.

Denki Kagaku Kogyo Co., Ltd., FP70, average particle size 70 μm. Aspect ratio 1-2.

Flat Boron Nitride Particles

Denki Kagaku Kogyo Co., Ltd., SP-3, average particle size 4 μm. Aspect ratio 20.

Denki Kagaku Kogyo Co., Ltd., MGP, average particle size 10 μm. Aspect ratio 50.

Denki Kagaku Kogyo Co., Ltd., XGP, average particle size 30 μm. Aspect ratio 150.

### SPECIFIC EXAMPLES

### Comparative Example 1

### Use of Spherical BN Particles

Thermoplastic resin PFA1 and spherical boron nitride particles (average particle size 70 μm) filler were mixed at a volume ratio of 43:57 to make a 30 g sample. The sample was dry blended for 15 seconds at room temperature in a coffee mill (Yamada Denki Kogyo Co., Ltd., BC-1752J) to obtain a mixed composition.

The mixed composition was put in a metal mold (55 mm diameter, 30 mm height), using a compression molding press (Hot Press WFA-37, Sinto Metal Industries, cylinder diameter 152 mm), and maintained for 15 minutes at 360° C. After this, melt compression molding was conducted at 2 MPa in-cylinder pressure (hydraulic pressure) of the compression molding press (the actual press pressure of the die: 15.3 MPa), and the thermal conductivity, breakdown voltage, and flexibility of the obtained sample were measured. The thermal conductivity measurement results are shown in Table 1 and Table 3, and the measurement results for breakdown voltage and flexibility are shown in Table 3.

A result of 6.9 W/mK was obtained as the thermal conductivity of this molded product. The volume basis content ratio of the present invention (volume ratio:vol %) can be calculated from the specific gravity of the boron nitride particles (2.26) as well as the specific gravity of each resin that is used and their weight ratios.

### Comparative Example 2

A mixed composition of PFA1 and spherical boron nitride particles (average particle size 70 μm) was prepared by the procedure of Comparative Example 1, except using a 66.5:33.5 volume ratio of PFA1 to BN. The mixed composition was molded under the same conditions and evaluated as a mold sample per the procedure of Comparative Example 1. The thermal conductivity of this molded product measured 3.5 W/mK, a significant decline in comparison to Comparative Example 1.

### Comparative Example 3

A mixed composition of PFA1 and spherical boron nitride particles (average particle size 40 μm) was prepared by the procedure of Comparative Example 1. The mixed composition was molded under the same conditions and evaluated as a mold sample per the procedure of Comparative Example 1. The thermal conductivity of this molded product measured 5.3 W/mK, a significant decline in comparison to Comparative Example 1.

From the results of the Comparative Examples 1-3, in the case of using resin composition and spherical boron nitride particles, the conditions of Comparative Example 1 display a relatively high thermal conductivity, so this ratio of resin to BN (43:57) was used as a reference, and using BN particles with different shapes, a composition and a molded product was made, and their thermal conductivity was evaluated.

### Comparative Example 4

### Use of Flat BN Particles

A mixed composition of PFA1 and flat boron nitride particles (average particle size 30 μm, aspect ratio: 150) was prepared by the procedure of Comparative Example 1. The mixed composition was molded under the same conditions and evaluated as a mold sample per the procedure of Comparative Example 1. The thermal conductivity of this molded product measured 2.1 W/mK, a significant decline in comparison to Comparative Example 1.

### Comparative Example 5

### Two Types of BN Particles

A mixed composition of PFA1 and a 1:1 volume mixture of spherical boron nitride particles (average particle size 70 μm) and flat boron nitride particles (average particle size 30 μm, aspect ratio: 150) was prepared by the procedure of Comparative Example 1. The mixed composition was molded under the same conditions and evaluated as a mold sample per the procedure of Comparative Example 1. The thermal conductivity of this molded product measured 4.9 W/mK, a significant decline in comparison to Comparative Example 1.

### Example 1

A mixed composition of PFA1 and a 95:5 volume mixture of spherical boron nitride particles (average particle size 70 μm) and flat boron nitride particles (average particle size 30 μm, aspect ratio: 150) was prepared by the procedure of Comparative Example 1. The mixed composition was molded under the same conditions and evaluated as a mold sample per the procedure of Comparative Example 1. The thermal conductivity of this molded product measured 9.9 W/mK, a desirable and significant increase in comparison to Comparative Example 1.

### Example 2

A mixed composition of PFA1 and a 95:5 volume mixture of spherical boron nitride particles (average particle size 70 μm) and flat boron nitride particles (average particle size 10 μm, aspect ratio: 50) was prepared by the procedure of Comparative Example 1. The mixed composition was molded under the same conditions and evaluated as a mold sample per the procedure of Comparative Example 1. The thermal conductivity of this molded product measured 8.7 W/mK, a desirable and significant increase in comparison to Comparative Example 1.

### Comparative Example 6

A mixed composition of PFA1 and a 95:5 volume mixture of spherical boron nitride particles (average particle size 70 μm) and flat boron nitride particles (average particle size 4 μm, aspect ratio: 20) was prepared by the procedure of Comparative Example 1. The mixed composition was molded under the same conditions and evaluated as a mold sample per the procedure of Comparative Example 1. The thermal conductivity of this molded product measured 6.5 W/mK, a desirable and significant decline in comparison to Comparative Example 1.

### Example 3

A mixed composition was prepared as in Example 1, except the amount of spherical boron nitride particles (average particle size: 70 μm) is 54% and the amount of flat boron nitride particles (average particle size: 30 μm, aspect ratio: 150) is increased from 3% to 9%, and the amount of PFA-1 is decreased from 43% to 37%. The mixed composition was prepared by the procedure of Comparative Example 1. The mixed composition was molded under the same conditions and evaluated as a mold sample per the procedure of Comparative Example 1. The thermal conductivity of this molded product measured 7.3 W/mK, a desirable and slight increase in comparison to Comparative Example 1.

### Example 4

A mixed composition was prepared following the procedure of Example 1. The amount of flat boron nitride particles (average particle size: 30 μm, aspect ratio: 150) was maintained at 3%. The amount of spherical boron nitride particles was increased from 54% to 60%, and the amount of PFA-1 was decreased from 43% to 37%. The mixed composition was molded under the same conditions and evaluated as a mold sample per the procedure of Comparative Example 1. The thermal conductivity of this molded product measured 8.5 W/mK.

### Example 5

A mixed composition was prepared following the procedure of Example 1. The amount of flat boron nitride particles (average particle size: 30 μm, aspect ratio: 150) was maintained at 3%. The amount of spherical boron nitride particles (average particle size: 70 μm) was increased from 54% to 70%, and the amount of PFA-1 was decreased from 43% to 27%. The mixed composition was molded under the same conditions and evaluated as a mold sample per the procedure of Example 1. The thermal conductivity of this molded product measured 10.7 W/mK, a significantly good result.

### Example 6

A mixed composition was prepared following the procedure of Example 1. The amount of flat boron nitride particles (average particle size: 30 μm, aspect ratio: 150) was maintained at 3%. The amount of spherical boron nitride particles (average particle size: 70 μm) was increased from 54% to 75%, and the amount of PFA-1 was decreased from 43% to 22%. The mixed composition was molded under the same conditions and evaluated as a mold sample per the procedure of Example 1. The thermal conductivity of this molded product measured 9.8 W/mK, a significantly good result.

### Example 7

A mixed composition was prepared following the procedure of Example 1. However, thermoplastic resin PFA2 was used in place of PFA1. The mixed composition was molded under the same conditions and evaluated as a mold sample per the procedure of Example 1. The thermal conductivity of this molded product measured 10.2 W/mK, a better result than Example 1 which used PFA1.

The compositions of Examples 1-7 and Comparative Examples 1-6 along with the evaluation results of thermal conductivity are shown in Table 1.

TABLE 1
Composition and thermal conductivity of the present invention

| | Thermoplastic | | | | | | Thermal |
|---|---|---|---|---|---|---|---|
| | resin | Spherical | Flat | BN total | Spherical | Flat BN | conductivity |
| | (PFA1) | BN (70μ) | BN (30μ) | amount | BN ratio | ratio | (W/mK) |
| Comparative | 43 | 57 | — | 57 | 100% | 0% | 6.9 |
| Example 1 | | | | | | | |
| Comparative | 66.5 | 33.5 | — | 33.5 | 100% | 0% | 3.5 |
| Example 2 | | | | | | | |
| Comparative | 43 | 57*(40μ) | — | 57 | 100% | 0% | 5.3 |
| Example 3 | | | | | | | |
| Comparative | 43 | — | 57 | 57 | 0% | 100% | 2.1 |
| Example 4 | | | | | | | |
| Comparative | 43 | 28.5 | 28.5 | 57 | 50% | 50% | 4.9 |
| Example 5 | | | | | | | |
| Example 1 | 43 | 54 | 3 | 57 | 95% | 5% | 9.9 |
| Example 2 | 43 | 54 | 3** (10μ) | 57 | 95% | 5% | 8.7 |
| Comparative | 43 | 54 | 3*** (4μ) | 57 | 95% | 5% | 6.5 |
| Example 6 | | | | | | | |
| Example 3 | 37 | 54 | 9 | 63 | 86% | 14% | 7.3 |
| Example 4 | 37 | 60 | 3 | 63 | 95% | 5% | 8.5 |
| Example 5 | 27 | 70 | 3 | 73 | 96% | 4% | 10.7 |
| Example 6 | 22 | 75 | 3 | 78 | 96% | 4% | 9.8 |
| Example 7 | 43**** PFA2 | 54 | 3 | 57 | 95% | 5% | 10.2 |

*(40μ)spherical BN with a particle size of 40μ was used instead of spherical BN with a particle size of 70μ
** (10μ)flat BN with a particle size of 10μ was used instead of flat BN with a particle size of 30μ
*** (4μ)flat BN with a particle size of 4μ was used instead of flat BN with a particle size of 30μ
**** PFA2PFA2 was used instead of PFA1 as the thermoplastic resin

Regarding Example 1, a fractured surface was obtained by cooling with liquid nitrogen the circular disc shaped film used for measuring the thermal conductivity, and fracturing it thereafter. The fractured surface was then observed with a scanning electron microscope (SEM). It was confirmed from the SEM photograph of Example 1, shown in FIG. 1 and FIG. 2, that the flat boron nitride particles are sandwiched by spherical boron nitride particles and randomly oriented.

### Example 8

### Changing the Melt Compression Pressure

A mixed composition was prepared following the procedure of Example 1, with the following change. The in-cylinder pressure for the melt compression molding was changed from 2 MPa to 1 MPa (the actual press pressure of the die was 7.64 MPa). The mixed composition was molded under the same conditions and evaluated as a mold sample per the procedure of Example 1. The measured thermal conductivity is shown in Table 2. The measured flexibility and breakdown voltage are shown in Table 3. A surprising result of 10.4 W/mK was obtained for the thermal conductivity of this molded product, significantly better than Example 1.

### Example 9

A mixed composition was prepared following the procedure of Example 5, with the following change. The in-cylinder pressure for the melt compression molding was changed from 2 MPa to 1 MPa. The mixed composition was molded under the same conditions and evaluated as a mold sample per the procedure of Example 5. The measured thermal conductivity is shown in Table 2. A surprising result of 11.3 W/mK was obtained for the thermal conductivity of this molded product, significantly better than Example 5.

Comparing the results of Example 8 with those of Example 1, and comparing the results of Example 5 and those of Example 9, it is observed that the thermal conductivity improves when the melt-molding pressure is reduced. This is believed to be the result of a fraction of the boron nitride particles being destroyed if the pressure is too high during melt molding.

### Example 10

A mixed composition was prepared following the procedure of Example 8, with the following change. The thermoplastic resin was changed from PFA1 to PFA3. The mixed composition was molded under the same conditions and evaluated as a mold sample per the procedure of Example 8. A good result of 8.7 W/mK was obtained for the thermal conductivity of this molded product.

Further, the crack generating angle according to the flexibility measurement is 90°, displaying a significant improvement in flexibility when compared to other samples.

### Example 11

A mixed composition was prepared following the procedure of Example 8, with the following change. The thermoplastic resin was changed from PFA1 to PFA4. The mixed composition was molded under the same conditions and evaluated as a mold sample per the procedure of Example 8. A good result of 8.6 W/mK was obtained for the thermal conductivity of this molded product.

Further, the crack generating angle according to the flexibility measurement is 80°, displaying a significant improvement in the flexibility when compared to other samples.

### Example 12

A mixed composition was prepared following the procedure of Example 9, with the following change. The thermoplastic resin was changed from PFA1 to PFA3. The mixed composition was molded under the same conditions and evaluated as a mold sample per the procedure of Example 9. A significantly good result of 9.2 W/mK was obtained for the thermal conductivity of this molded product.

### Example 13

A mixed composition was prepared following the procedure of Example 8, with the following change. The thermoplastic resin was changed from PFA1 to PEEK. The mixed composition was molded under the same conditions and evaluated as a mold sample per the procedure of Example 8. A result of 7.7 W/mK was obtained for the thermal conductivity of this molded product, a result that is better than Example 1.

The compositions of Examples 8-13 along with the evaluation results of thermal conductivity are shown in Table 2.

TABLE 2
Composition and thermal conductivity of the present invention

| | | | | | | | Thermal |
|---|---|---|---|---|---|---|---|
| | Thermoplastic | Spherical | Flat | BN total | Spherical | Flat | conductivity |
| | resin | BN (70μ) | BN (30μ) | amount | BN ratio | BN ratio | W/mK |
| Example 8 | 43 PFA1 | 54 | 3 | 57 | 95% | 5% | 10.4 |
| Example 9 | 27 PFA1 | 70 | 3 | 73 | 95% | 5% | 11.3 |
| Example 10 | 43* PFA3 | 54 | 3 | 57 | 95% | 5% | 8.7 |
| Example 11 | 43** PFA4 | 54 | 3 | 57 | 95% | 5% | 8.6 |
| Example 12 | 27* PFA3 | 70 | 3 | 73 | 96% | 4% | 9.2 |
| Example 13 | 43*** PEEK | 54 | 3 | 57 | 95% | 5% | 7.7 |

* PFA3PFA3 was used instead of PFA1 as the thermoplastic resin
** PFA4PFA4 was used instead of PFA1 as the thermoplastic resin
*** PEEKPEEK was used instead of PFA1 as the thermoplastic resin

The evaluation results and their summary for the breakdown voltage and the flexibility test for Examples 1-7, 10-11, 13, and the sample of Comparative Example 1 are shown in Table 3.

TABLE 3
Thermal conductivity and flexibility evaluation results

| | Thermal | Breakdown | Brittleness: | |
|---|---|---|---|---|
| | conductivity | voltage | crack generating | Brittleness |
| Example | W/mK | (median) kV | angle | ranking |
| Example 1 | 9.9 | 8.9 | 35 | Δ |
| Example 2 | 8.7 | 10 | 35 | Δ |
| Example 3 | 7.3 | 10.5 | 30 | Δ |
| Example 4 | 8.5 | 13.6 | 30 | Δ |
| Example 5 | 10.7 | 9.7 | 25 | Δ |
| Example 6 | 9.8 | 17 | 20 | Δ |
| Example 7 | 10.2 | 10 | 10 | Δ |
| (PFA2) | | | | |
| Example 10 | 8.7 | — | 90 | ◯ |
| (PFA3) | | | | |
| Example 11 | 8.6 | — | 80 | ◯ |
| (PFA4) | | | | |
| Example 13 | 7.7 | 8.5 | 10 | — |
| (PEEK) | | | | |
| Comparative | 6.9 | 10.9 | 15 | Δ |
| Example 1 | | | | |

In the case where the molded product of the present invention is used as a heat dissipating material for electronic components, especially as a heat dissipating material for power semiconductors and power modules, extremely high electrical insulating properties are required. For this reason, the breakdown voltage (measured value) of the molded product is at least greater than or equal to 5 kV, and preferably greater than or equal to 7 kV, and more preferably greater than or equal to 9 kV. The breakdown voltage is affected by the physical properties and the dispersion state of the filler included in the resin composition. The breakdown voltage is large with Example 4 and Example 6, and especially Example 6, but this is because boron nitride is a filler with high insulating properties, so in a resin composition that includes an abundance of this boron nitride, the insulating properties have improved. Further, the breakdown voltage is, if only slightly, smaller in Example 13. This is thought to be because the thermoplastic resin that was used was PEEK, and compared to PFA, it has inferior electrical insulating properties.

By comparing Example 1 and Comparative Example 1, it can be seen that the flexibility of the resin part containing boron nitride as the filler is improved, as compared to the flexibility of a resin part using spherical boron nitride particles alone, by using flat boron nitride particles together with the spherical boron nitride particles. Further, by using a resin with a low MFR (PFA3 and PFA4, MFR: 2 g/10 min), as seen from Example 10 and Example 11, as compared to Example 1 and Example 7, it can be seen that brittleness is significantly improved and flexibility is improved.

What is claimed is:

1. A resin composition comprising 20-60 volume percent thermoplastic resin and 40-80 volume percent boron nitride, wherein said boron nitride comprises spherical boron nitride particles and flat boron nitride particles, said spherical boron nitride particles having an average particle size of 50-300 μm and an aspect ratio of 1-2, said flat boron nitride particles having an average particle size of 8-100 μm and an aspect ratio of 30-300, and the amount of said spherical boron nitride particles with respect to the total amount of boron nitride is 75-99 volume percent.

2. The resin composition of claim 1, wherein the average particle size of said spherical boron nitride particles divided by the average particle size of said flat boron nitride particles is in the range of 1-10.

3. The resin composition of claim 1, wherein said spherical boron nitride particles have an average particle size of 60-100 μm and an aspect ratio of 1-2, and said flat boron nitride particles have an average particle size of 20-50 μm and an aspect ratio of 60-300.

4. The resin composition of claim 1, wherein the amount of said spherical boron nitride particles with respect to the total amount of boron nitride is 85-98 volume percent.

5. The resin composition of claim 1, comprising 30-50 volume percent of said thermoplastic resin and 50-70 volume percent of said boron nitride

6. The resin composition of claim 1, wherein said thermoplastic resin is a fluorine resin.

7. The resin composition of claim 6, wherein said fluorine resin is at least one perfluorinated resin selected from the group consisting of PTFE, PFA, FEP, and tetrafluoroethylene, hexafluoropropylene and perfluoro(alkyl vinyl ether) copolymer.

8. A manufacturing method for a molded product wherein the resin composition of claim 1 is mixed using a method selected from the group consisting of dry blending, wet blending, and co-coagulation, after which it is melt molded.

9. A molded product manufactured from the resin composition of claim 1.

10. The molded product of claim 9, wherein the thermal conductivity is greater than or equal to 8.5 W/mK.

11. The molded product of claim 9 in the form of a sheet, film, or tube.
